(19) United States
(12) Patent Application Publication
(10) Pub. No.: US 2009/0219660 A1
(43) Pub. Date: Sep. 3, 2009

(54) DIGITAL INTERFACE USED IN MULTI-SERIES-PARALLEL BATTERY MODULES

(75) Inventors: Ying-How SHU, Taipei (TW); Feng-Yuan WANG, Taipei (TW)

Correspondence Address: SCHMEISER OLSEN & WATTS, 18 E UNIVERSITY DRIVE, SUITE # 101, MESA, AZ, 85201, US

(73) Assignee: ALL NEW ENERGY TECHNOLOGY CORP., Taipei (TW)

(21) Appl. No.: 12/201,346

(22) Filed: Aug. 29, 2008

(30) Foreign Application Priority Data
Feb. 29, 2008 (TW) 097203419

(51) Int. Cl. H02H 3/20

(52) U.S. Cl. 361/90

(57) ABSTRACT

A digital interface used in multi-series-parallel battery modules is provided and applies the Universal Asynchronous Receiver/Transmitter interface. An Up-Link circuit and a Down-Link circuit are construed by voltage isolation elements for directly connecting a Low Voltage Protection signal of a battery cell, and an Over Voltage Protection signal of the battery cell in series, in associated with receiving and transmission signals of universal asynchronous receiving/transmission, and initiating a forced WakeUp signal of a Micro Control Unit, MCU, of a battery module protection circuit board of each digital interface of the battery modules. The battery monitoring system formed allows battery modules of standard specification to be directly connected to digital signal for monitoring batteries in series, for a plurality of battery modules to be easily connected in multi-series-parallel, and for the battery module to be easily replaced during maintenance to dramatically reduce costs associated with maintenance and custom battery designs.

### BACKGROUND OF THE INVENTION

1. Field of the Invention

The present invention relates to a digital interface used in multi-series-parallel battery modules. More particularly, the present invention relates to a digital interface used in multi-series-parallel battery modules that allows battery modules of standard specification to be directly connected the digital signal used in a battery monitoring system. This invention also allows a plurality of battery modules to be easily connected and used in multi-series-parallel configuration. Therefore, maintenance personnel can replace any set of batteries on an as-needed basis thereby decreasing the costs associated with maintenance and the costs associated with the design of custom battery modules.

2. Description of the Related Art

In the electric vehicle market, digital interfaces are widely used in the power system of electric vehicles to control battery charging, discharging, and monitoring of residual battery energy as well as other operations. As electric vehicles have developed, battery capacity and power have gradually improved. Focusing on optimizing batteries' capacity, use of multi-series-parallel battery modules has become a trend in the development of power systems for electric vehicles. However, replacement and maintenance of the multi-series-parallel battery modules are a major issue for digital monitoring systems. Conventionally, most published patents relating to digital interface management of batteries apply “Controller Area Network communication interfaces of controlling Network Connection;” “Star Connection of One-Wire, Maxim/HDQ Bus, Ti;” or “Smart Management Bus, Intel/CAN-Bus Controller Area Network” as their digital-information-integrated interfaces. These kinds of communication interfaces avoid Master/Slave configuration issues, but have transmission delay issues when they are used in multi-series-parallel systems due to collision issues caused by transmission delay. An additional issue to be considered is that use of multi-series-parallel battery modules requires an increase in battery voltage which results in different voltage levels in each battery module.

Therefore it becomes clear that the aforementioned products still have many drawbacks and improved designs are needed.

The inventor addressed the aforementioned drawbacks associated with conventional technologies and after extensive research developed the present invention of a digital interface for use in multi-series-parallel battery modules.

### SUMMARY OF THE INVENTION

The primary objective of the present invention is to provide a digital interface for use in multi-series-parallel battery modules. The purpose of present invention is to solve the issue that occurs when the multi-series-parallel battery modules mutually communicate with digital communication signals. The protection boards of the series of battery modules have different operational reference voltages which will result in an increased voltage when connected. This increase in voltage may cause a difference in operational reference voltage of up to 300-500 volts thereby causing a conventional Network Connection or Star Connection configuration to malfunction.

The present invention applies to technologies using the Universal Asynchronous Receiver/Transmitter interface, RS-232, and an Up-Link circuit and a Down-Link circuit that are comprised of voltage isolation elements for directly connecting to a Low Voltage Protection signal and an Over Voltage Protection signal from a battery cell, receiving and transmitting universal asynchronous receiving/transmission signals, and initiating a forced WakeUp signal from a Micro Control Unit (MCU) of a battery module protection circuit board on each digital interface of the battery modules in series. Since the Universal Asynchronous Receiver/Transmitter interface built into the MCU is designed with a transmission buffer, the transmission delay time caused by the voltage isolation elements in multi-series-parallel does not cause errors in signal transmission. By considering difference between the Rising Time and Falling Time of a signal waveform in the circuit design, or by using a Baud Rate in transmission, the issue of transmission can be solved.

The digital interface applies simple DIP switches as identification codes for multi-series-parallel battery modules. The identification codes are limited in quantity. As a result, a power system for monitoring all modules can set up all battery protection system configurations by sequentially scanning the limited codes without pre-setting the identification codes. Moreover, since the way of assigning identification codes uses visible DIP switches, maintenance operations become very easy and technical skill requirements for maintenance operations are dramatically decreased since the maintenance personnel only need to follow the original configuration of the DIP switches to change the battery modules.

After each protection board of the battery modules assigns the identification codes, the monitoring system can call on a protection board of a single battery module. The protection board with the corresponding identification code would respond with a pre-determined data module and status signals. The digital interface mentioned in the present invention also includes an Over Voltage Protection signal and a Low Voltage Protection signal that are generally used in a conventional battery management system. The difference between the present invention and conventional designs is that the Over Voltage Protection signal and Low Voltage Protection signal are status signals in the present invention. The design of the interface allows the two status signals to be sequentially shown in next stage. If any battery module fails, the two status signals are transmitted to the last battery module and are presented on the last stage of the digital interface.

### BRIEF DESCRIPTION OF THE DRAWINGS

FIG. 1 shows an Up-Link circuit with voltage isolation of the present invention;

FIG. 2 shows a Down-Link circuit with voltage isolation of the present invention;

FIG. 3 shows an embodiment of the digital interface used in multi-series-parallel battery modules of the present invention;

FIG. 4 shows an embodiment of the battery protection board configured to operate with the digital interface of the present invention for the multi-series-parallel battery modules; and

FIG. 5 shows an embodiment of four battery protection boards connected in series configured to operate with the digital interface of the present invention for the multi-series-parallel battery modules.

### DESCRIPTION OF THE PREFERRED EMBODIMENT

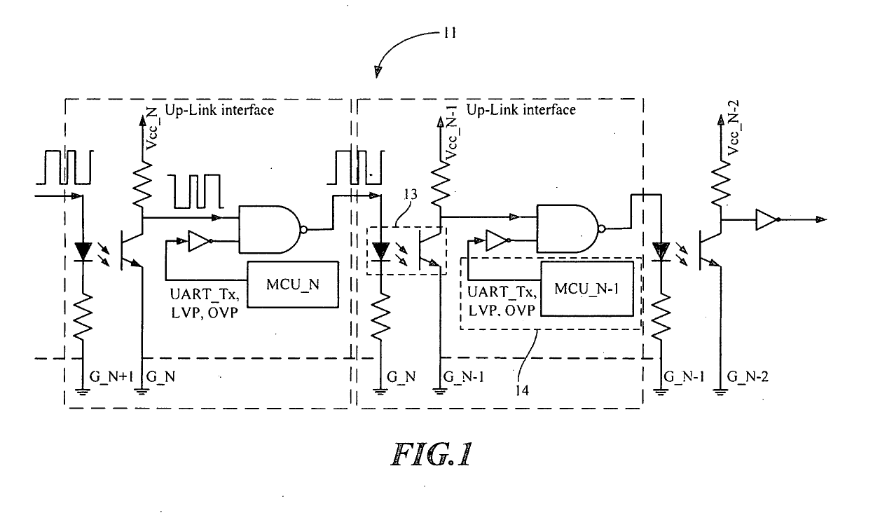

An Up-Link circuit with voltage isolation in the present invention as shown in FIG. 1. The design of the Up-Link circuit 11 uses a voltage isolation element 13 which is a Photo-Coupler. Generally the Universal Asynchronous Receiver/Transmitter interface signal presents a voltage level of “1” in static status in order to effectively reduce power consumption in static status. An inverting interface signal is also used in the circuit which means that the signal presented in the interface has 180° difference from the real signal in phase. The voltage isolation element 13 in the circuit can be a Photo-MOSFET or a Photo-Relay to achieve similar objectives in the circuit. A logic circuit 14 of the circuit is construed by a standard logic gate, a Bi-Polar Transistor (BJT), a Field-Effect Transistor (FET), or a Metal-Oxide-Semiconductor Field-Effect Transistor (MOSFET) to effectively reduce the circuit size of the digital interface.

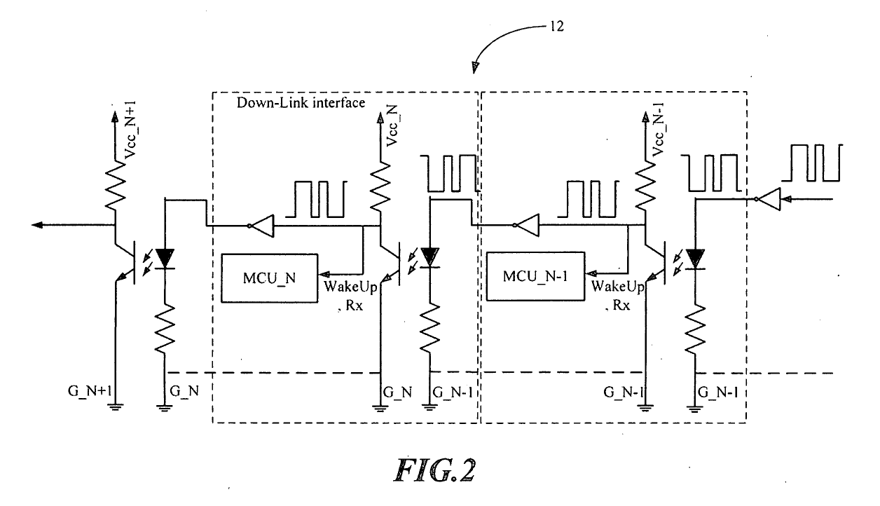

A Down-Link circuit with voltage isolation in the present invention as shown in FIG. 2. The Down-Link circuit 12 capable of voltage isolation has a circuit layout mostly opposite to the Up-Link circuit as shown in FIG. 1. The logic circuit of the interface is properly modified to adjust the accuracy of the signal transmission.

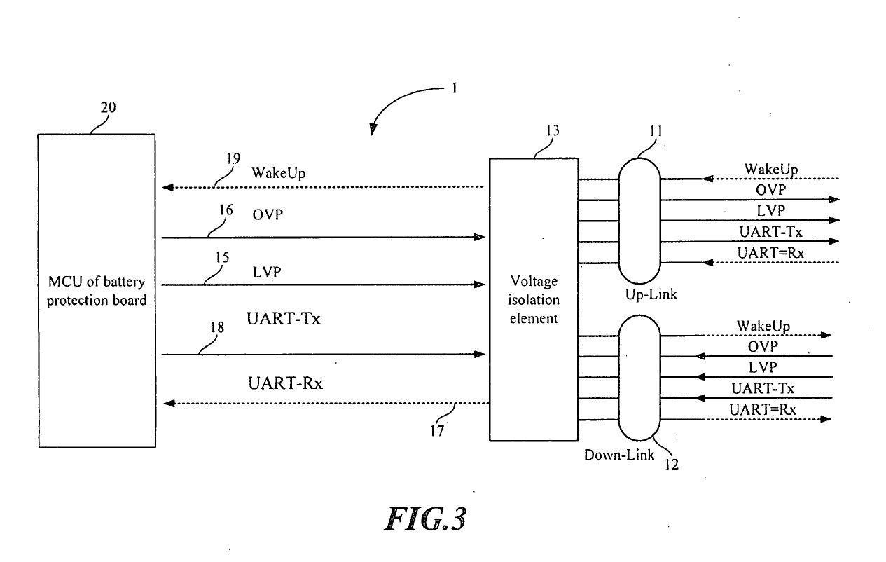

An embodiment of the digital interface used in multi-series-parallel battery modules of the present invention is shown in FIG. 3. The digital interface 1 of the present invention applies the Universal Asynchronous Receiver/Transmitter interface, RS-232. In addition, the Up-Link circuit 11 and the Down-Link circuit 12 are comprised of voltage isolation elements 13 for directly connecting the low voltage protection signal 15 of a battery cell, an over voltage protection signal 16 of the battery cell, receiving and transmission signals 17, universal asynchronous receiving/transmission 18, and initiating a forced WakeUp signal 19 of a MCU 20 of a battery module protection circuit board on each digital interface of the battery modules in series. Since the Universal Asynchronous Receiver/Transmitter interface built-in with the MCU 20 is designed with a transmission buffer, the transmission delay time caused by the multi-series-parallel voltage isolation elements 13 does not cause signal transmission errors. By considering difference of Rising Time and Falling Time of signal waveforms in circuit design, or by using Baud Rate in transmission, the issues of transmission can be solved. The present invention provides a digital interface that is applicable in multi-series-parallel battery modules and uses the voltage isolation elements 13. Therefore the interface signals can be input from signal sources with different voltage levels, and can be merged with a signal of the present stage for output.

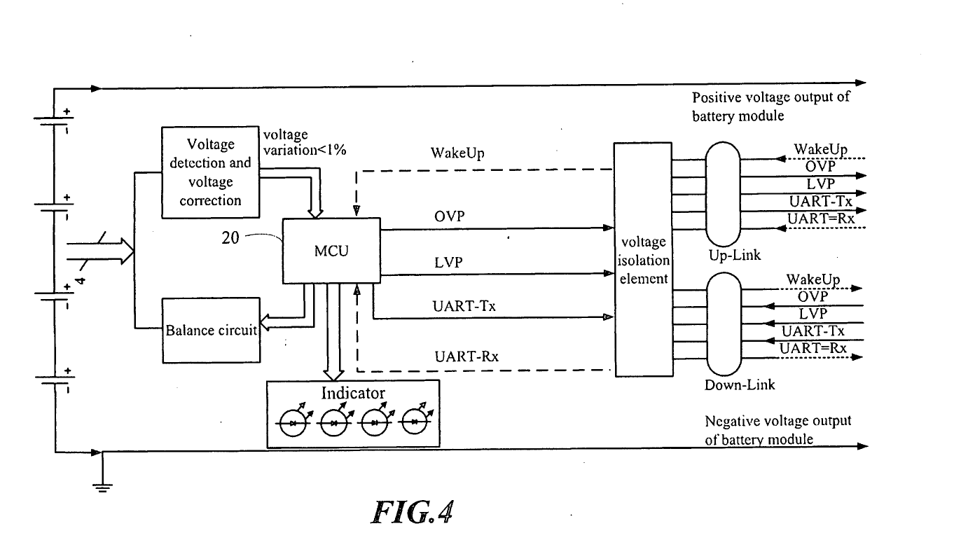

Referring to FIG. 4, an embodiment of the battery protection board configured to operate with the digital interface of the present invention for the multi-series-parallel battery modules is shown. The present invention uses the Universal Asynchronous Receiver/Transmitter interface as the digital interface. Thus the buffer register built in the MCU 20 is configured to take the program codes for monitoring battery status and balance mechanism calculation as the first priority and will not be interfered by demands of Interruption from digital communication.

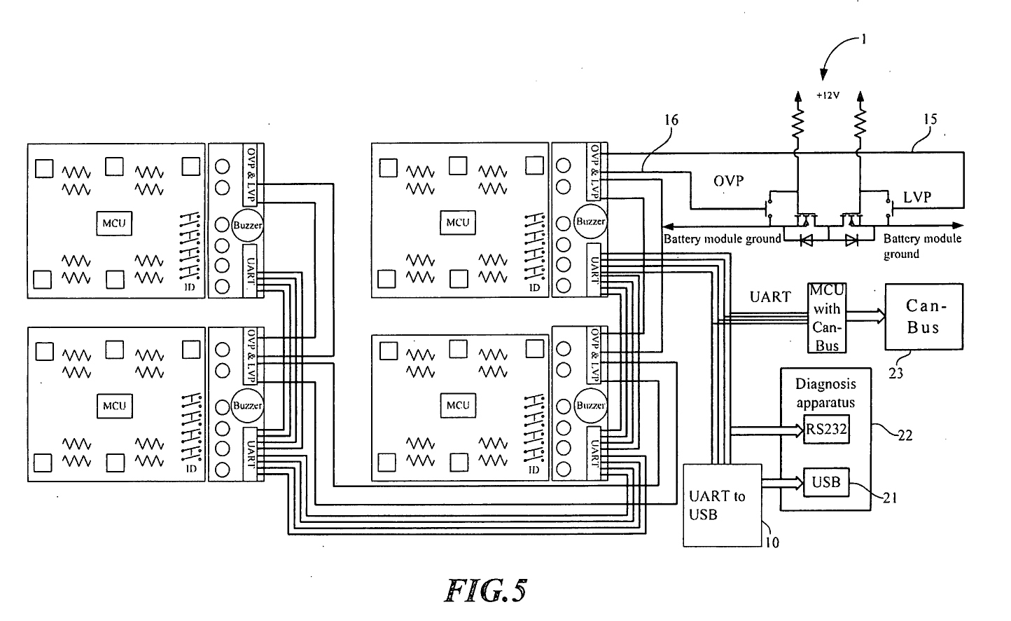

Referring to FIG. 5, an embodiment of four battery protection boards connected in series configured to operate with the digital interface of the present invention for the multi-series-parallel battery modules is shown. The digital interface 1 of the present invention is configured to connect the Low Voltage Protection signal 15 and the Over Voltage Protection signal 16 in series in order to control the power output/input switches of the battery. When any one module of the four battery protection boards outputs a Low Voltage signal or an Over Voltage signal, the signal is then transmitted to the corresponding switch via the digital interface 1 connected in series to turn off the discharging switch or the charging switch to achieve the function of voltage protection for protection of the battery. And the Universal Asynchronous Receiver/Transmitter interface 10 is configured to feed back the digital data, such as voltage of each battery cell, capacity of capacitor set, and etc., for a diagnosis apparatus 22 in response to operation commands of the diagnosis apparatus 22 via a voltage level converting circuit or a Universal Serial Bus, USB 21. In addition, the Universal Asynchronous Receiver/Transmitter interface 10 is configured to transmit an over voltage signal and a low voltage signal in accordance with the diagnosis apparatus. The digital interface 1 in series connection is configured to communicate with all battery protection boards and a monitoring system, and is also configured to diagnosis the function of the battery protection board via a corresponding diagnosis program. Since the Universal Asynchronous Receiver/Transmitter interface is a universal interface for the MCU, with certain special applications, an external bridge board may be applied for transmitting the digital signals into a control network interface. For example, a CAN-Bus interface 23 that is generally applied in a car computer may be applied. As a result, the battery system is treated as a sub-system of an In-Vehicle system.

In comparison with other conventional technologies, the digital interface used in multi-series-parallel battery modules of the present invention has the following advantages:

1. The digital interface used in multi-series-parallel battery modules of the present invention can be used in a battery monitoring system and allows battery modules with the same standard to directly connect to digital signals in series.

2. The digital interface used in multi-series-parallel battery modules of the present invention is convenient in that a plurality of battery modules can be connected in multi-series-parallel for use, and the battery module needed to be changed can be replace easily during maintenance to dramatically reduce costs associated with the design and maintenance of battery power.

3. The digital interface used in multi-series-parallel battery modules of the present invention dramatically simplifies circuit complexity of conventional multi-series-parallel battery modules, and reduces the circuit size of the digital interface.

The aforementioned detailed description is for explaining a particular embodiment of the present invention, and the embodiment is not applied to limit the present invention. The equivalent embodiment of modification after understanding the present invention shall be within the scope of the invention.

As aforementioned, the present invention is novel in technology and advantaged in many effects that the prior arts lack. The present invention conforms to the novelty and non-obviousness of patentability.

What is claimed is:

1. A digital interface used in multi-series-parallel battery modules, in which the Universal Asynchronous Receiver/Transmitter interface is used, and an Up-Link circuit and a Down-Link circuit are construed by voltage isolation elements for directly connecting a Low Voltage Protection signal, an Over Voltage Protection signal, receiving and transmission signals of universal asynchronous receiving/transmission, and initiating a forced WakeUp signal of a Micro Control Unit, MCU, of a battery module protection circuit board on each digital interface of the battery modules in series.

2. The digital interface used in multi-series-parallel battery modules as claimed in claim 1, wherein the voltage isolation element is a Photo-Coupler, a photo-MOSFET, or a Photo-Relay.

3. The digital interface used in multi-series-parallel battery modules as claimed in claim 1, wherein a logic circuit of the digital interface can be construed by a standard logic gate, a Bi-Polar Transistor (BJT), a Field-Effect Transistor (FET), or a Metal-Oxide-Semiconductor Field-Effect Transistor (MOSFET).

4. The digital interface used in multi-series-parallel battery modules as claimed in claim 1, wherein the digital interface is capable of direct series-connection.

5. The digital interface used in multi-series-parallel battery modules as claimed in claim 1, wherein a data port of the digital interface is configured to communicate in an asynchronous transmitting mode.

6. The digital interface used in multi-series-parallel battery modules as claimed in claim 1, wherein the digital interface has an Up-Link interface and a Down-Link interface, and the Up-Link function and Down-Link function thereof are operated independently.

7. The digital interface used in multi-series-parallel battery modules as claimed in claim 1, wherein the status signal of the digital interface is not limited to the Low Voltage Protection signal and the Over Voltage Protection signal, and an alarm sound signal, a battery cell abnormal signal, and a WakeUp signal for initiating the MCU in associated with operation of a diagnosis apparatus that are set in accordance with operation requirements.

8. The digital interface used in multi-series-parallel battery modules as claimed in claim 1, wherein the digital interface applies a simple DIP switch as an identification code for a multi-series-parallel battery module, and the identification codes are limited in quantity thus a power system for monitoring the whole can set up all configurations of battery protection system by sequentially scanning the limited codes without pre-setting the identification codes.

9. The digital interface used in multi-series-parallel battery modules as claimed in claim 1, wherein the digital interface, applying the Universal Asynchronous Receiver/Transmitter interface as a universal interface of the MCU, is capable of applying an external bridge board for transmitting the digital signals into a control network interface for a further application.

10. The digital interface used in multi-series-parallel battery modules as claimed in claim 1, wherein the Universal Asynchronous Receiver/Transmitter interface is configured to feed back the digital data for a diagnosis apparatus in response to operation commands of the diagnosis apparatus via a voltage level converting circuit or an Universal Serial Bus, and is configured to transmit an over voltage signal and a low voltage signal in accordance with the diagnosis apparatus, the digital interface in series connection is configured to connect all battery protection boards in series with a monitoring system, and is also configured to diagnosis the function of the battery protection board via a corresponding diagnosis program.
